(19) United States
(12) Patent Application Publication
(10) Pub. No.: US 2024/0014442 A1
(43) Pub. Date: Jan. 11, 2024

(54) ALUMINUM-AIR SECONDARY BATTERY AND MANUFACTURING METHOD THEREFOR

(71) Applicant: INDUSTRY-UNIVERSITY COOPERATION FOUNDATION HANYANG UNIVERSITY ERICA CAMPUS, Ansan-si (KR)

(72) Inventors: Jung Ho Lee, Ansan-si (KR); Sambhaji Shivaji Shinde, Ansan-si (KR); Dong Hyung Kim, Ansan-si (KR); Sung Hae Kim, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 18/472,629

(22) Filed: Sep. 22, 2023

Related U.S. Application Data
(63) Continuation of application No. PCT/KR2022/004101, filed on Mar. 23, 2022.

(30) Foreign Application Priority Data
Mar. 23, 2021 (KR) 10-2021-0037491
Mar. 23, 2022 (KR) 10-2022-0036292

(51) Int. Cl. H01M 10/0565; H01M 4/46; H01M 4/58

(52) U.S. Cl. CPC H01M 10/0565; H01M 4/463; H01M 4/581; H01M 4/5805

(57) ABSTRACT

An aluminum-air secondary battery is provided. In an aluminum-air secondary battery capable of being charged and discharged multiple times, the aluminum-air secondary battery may comprise: a positive electrode including an electrode structure formed of a compound containing a transition metal, a chalcogen element, and phosphorus; a negative electrode disposed on the positive electrode and containing aluminum; and a solid electrolyte disposed between the positive electrode and the negative electrode and containing a base composite fiber having bacterial cellulose and chitosan bound to the bacterial cellulose.

### CROSS REFERENCE TO RELATED APPLICATIONS

This is a continuation of PCT/KR2022/004101 (filed 23 Mar. 2022), which claims the benefit of Republic of Korea Patent Application KR 10-2022-0036292 (filed 23 Mar. 2022) and Republic of Korea Patent Application KR 10-2021-0037491 (filed 23 Mar. 2021). The entire disclosure of each of these priority applications is hereby incorporated by reference herein.

### BACKGROUND OF THE INVENTION

### 1. Field of the Invention

The present application relates to an aluminum-air secondary battery and a method for manufacturing the same.

### 2. Description of the Prior Art

As mid-to-large high-energy applications such as electric vehicles, energy storage systems (ESS) and the like are rapidly growing beyond the existing secondary batteries for small devices and home appliances, the market value of the secondary battery industry was only about 22 billion dollars in 2018, but is expected to grow to about 118 billion dollars by 2025. As such, in order for secondary batteries to be used as medium and large-sized energy storage media, there is a demand for price competitiveness, energy density and stability which are significantly improved more than a current level.

According to the technical needs, various electrodes for secondary batteries have been developed.

For example, Korean Unexamined Patent Publication No. 10-2019-0139586 discloses an electrode for a lithium-air battery, which includes a carbon nanotube and RuO2 deposited on a surface of the carbon nanotube, in which the RuO2 is deposited on a surface defect site of the carbon nanotube; the RuO2 has a particle size of 1.0 to 4.0 nm; and the RuO2 inhibits carbon decomposition at a surface defect site of the carbon nanotube and promotes the decomposition of Li2O2 formed on the surface of the carbon nanotube.

### SUMMARY OF THE INVENTION

One technical object of the present application is to provide an aluminum-air secondary battery capable of being charged and discharged a plurality of times and a method for manufacturing the same.

Another technical object of the present application is to provide an aluminum-air secondary battery with a low manufacturing cost and a simple manufacturing process and a method for manufacturing the same.

Still another technical object of the present application is to provide an aluminum-air secondary battery with an enhanced charge/discharge capacity and a method for manufacturing the same.

Still another technical object of the present application is to provide an aluminum-air secondary battery with a long lifespan and high stability and a method for manufacturing the same.

The technical objects of the present application are not limited to the above.

To solve the above technical objects, the present application may provide an aluminum-air secondary battery.

According to one embodiment, in an aluminum-air secondary battery capable of being charged and discharged a plurality of times, the aluminum-air secondary battery may include: a positive electrode including an electrode structure formed of a compound containing a transition metal, a chalcogen element, and phosphorus; a negative electrode disposed on the positive electrode and containing aluminum; and a solid electrolyte disposed between the positive electrode and the negative electrode and containing a base composite fiber having bacterial cellulose and chitosan bound to the bacterial cellulose.

According to one embodiment, the electrode structure may include a membrane in which a plurality of fibrillated fibers form a network, and may be flexible.

According to one embodiment, the transition metal of the electrode structure may include at least one of Cu, Mn, Fe, Co, Ni, Zn, Mg, or Ca, and the chalcogen element of the electrode structure may include sulfur.

According to one embodiment, the solid electrolyte may include a first composite fiber that is formed as a surface of the base composite fiber is oxidized; and a second composite fiber that is formed as a first functional group having nitrogen is bound to a surface of the base composite fiber.

According to one embodiment, weight ratios of the first composite fiber and the second composite fiber in the solid electrolyte may be the same as each other.

According to one embodiment, the aluminum-air secondary battery may have a capacity of 1,800 mAh/g or more and an energy density of 3.00 Wh/Kg or more.

According to one embodiment, the transition metal of the electrode structure may include copper, and the electrode structure may be represented by <Formula 1> below.

CuPxSy <Formula 1>

(wherein x+y=1, 0.3≤x≤0.7, 0.3≤y≤0.7)

To solve the above technical objects, the present application may provide a method for manufacturing an aluminum-air secondary battery.

According to one embodiment, in a method for manufacturing an aluminum-air secondary battery capable of being charged and discharged a plurality of times, the method for manufacturing an aluminum-air secondary battery may include: providing a positive electrode including an electrode structure formed of a compound containing a transition metal, a chalcogen element, and phosphorus; disposing a solid electrolyte including bacterial cellulose, and a base composite fiber having chitosan bound to the bacterial cellulose, on the positive electrode; and disposing a negative electrode including aluminum on the solid electrolyte.

According to one embodiment, the providing of the positive electrode including the electrode structure may include: preparing a first precursor having a chalcogen element, a second precursor having phosphorus, and a third precursor having a transition metal; preparing a suspension by mixing the first precursor, the second precursor, and the third precursor in a first solvent; adding a reducing agent to the suspension and causing a reaction therebetween to produce an intermediate product; and adding the intermediate product and a surfactant to a second solvent and heat-treating under pressure, so as to manufacture the electrode structure including the chalcogen element, the phosphorus, and the transition metal.

According to one embodiment, the disposing of the solid electrolyte may include: providing a chitosan derivative; producing chitosan bound to cellulose from the chitosan derivative; and preparing a solid electrolyte by using the cellulose to which the chitosan is bound.

An aluminum-air secondary battery according to an embodiment of the present application may include: a positive electrode including an electrode structure formed of a compound containing a transition metal, a chalcogen element, and phosphorus; a negative electrode disposed on the positive electrode and containing aluminum; and a solid electrolyte disposed between the positive electrode and the negative electrode and containing a base composite fiber having bacterial cellulose and chitosan bound to the bacterial cellulose.

Accordingly, the aluminum-air secondary battery may be charged and discharged substantially a plurality of times to drive as a secondary battery, and may have a high capacity of 1,800 mAh/g or more and a high energy density of 3.00 Wh/Kg or more.

In addition, the secondary battery may be manufactured using an inexpensive aluminum material, thus reducing manufacturing costs of the secondary battery.

### BRIEF DESCRIPTION OF THE DRAWINGS

FIG. 1 is a flowchart for explaining a method for preparing a solid electrolyte of an aluminum-air secondary battery according to an embodiment of the present application.

FIG. 2 is views for explaining a solid electrolyte of a metal-air battery according to an embodiment of the present application and a method for preparing the same.

FIG. 3 is a flowchart for explaining a method for manufacturing an electrode structure for a positive electrode of a metal-air battery according to an embodiment of the present application.

FIG. 4 is a view for explaining a process of manufacturing an electrode structure for a positive electrode of a metal-air battery according to an embodiment of the present application.

FIG. 5 is a view for explaining a first composite fiber according to Experimental Example 1-2 of the present application, and a method for preparing the same.

FIG. 6 is a view for explaining a second composite fiber according to Experimental Example 1-3 of the present application, and a method for preparing the same.

FIG. 7 is a view for explaining a method for preparing a solid electrolyte according to Experimental Example 1-4 of the present application.

FIG. 8 is a view showing an SEM picture of a solid electrolyte prepared according to Experimental Example 1-4 of the present application.

FIG. 9 is a view showing results of measuring an ionic conductivity of a solid electrolyte including a third composite fiber according to Experimental Example 1-8 of the present application depending on a temperature.

FIG. 10 is a view showing results of measuring an ionic conductivity of a solid electrolyte including a functional fiber according to Experimental Example 1-9 of the present application depending on a temperature.

FIG. 11 is a view showing pictures of an electrode structure manufactured according to Experimental Example 2-1 of the present application.

FIG. 12 is an XRD graph of an electrode structure manufactured according to Experimental Example 2-1 of the present application.

FIG. 13 is a view showing SEM pictures of an electrode structure according to Experimental Example 2-1 of the present application.

FIG. 14 is a view showing TEM pictures of an electrode structure according to Experimental Example 2-1 of the present application.

FIG. 15 is a view showing a simulation and a lattice fringe image of an atomic structure of an electrode structure according to Experimental Example 2-1 of the present application.

FIG. 16 is a view showing an SEAD pattern of an electrode structure according to Experimental Example 2-1 of the present application.

FIG. 17 is a graph showing an evaluation of ORR, OER, and HER properties according to a composition ratio of P and S in an electrode structure according to Experimental Example 2-1 of the present application.

FIG. 18 is a graph showing a measurement of bifunctional activity of electrode structures according to Experimental Examples 3-1-1 and 3-1-5 of the present application.

FIG. 19 is a graph showing a measurement of bifunctional activity of electrode structures according to Experimental Examples 3-2-1 and 3-2-5 of the present application.

FIG. 20 is a graph showing a measurement of bifunctional activity of electrode structures according to Experimental Examples 3-3-1 and 3-3-6 of the present application.

FIG. 21 is a graph showing a measurement of bifunctional activity of electrode structures according to Experimental Examples 3-4-1 and 3-4-6 of the present application.

FIG. 22 is a view showing an SEM picture of an electrode structure according to Experimental Examples 3-5-1 to 3-5-6 of the present application.

FIG. 23 is a graph showing a measurement of bifunctional activity of electrode structures according to Experimental Examples 3-5-1 and 3-5-8 of the present application.

FIG. 24 is a graph for explaining a result of charge/discharge properties of an aluminum-air battery according to an experimental example of the present application.

### DETAILED DESCRIPTION OF THE EXEMPLARY EMBODIMENTS

Hereinafter, preferred embodiments of the present invention will be described in detail with reference to the accompanying drawings. However, the technical idea of the present invention is not limited to the embodiments described herein and may be embodied in other forms. The embodiments introduced herein are provided to sufficiently deliver the spirit of the present invention to those skilled in the art so that the disclosed contents may become thorough and complete.

In addition, in the various embodiments of the present specification, the terms such as first, second, and third are used to describe various elements, but the elements are not limited to the terms. These terms are used only to distinguish one element from another element. Accordingly, an element mentioned as a first element in one embodiment may be mentioned as a second element in another embodiment. Each of the embodiments described and illustrated herein also include their complementary embodiments. Further, the term “and/or” in the present specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added. In addition, the term “connection” used herein may include the meaning of indirectly connecting a plurality of components, and directly connecting a plurality of components.

Further, in the following description of the present invention, a detailed description of known functions and configurations incorporated herein will be omitted when it may make the subject matter of the present invention unnecessarily unclear.

An aluminum-air secondary battery according to an embodiment of the present application will be described. The aluminum-air secondary battery may include: a positive electrode including an electrode structure formed of a compound containing a transition metal, a chalcogen element, and phosphorus; a negative electrode disposed on the positive electrode and containing aluminum; and a solid electrolyte disposed between the positive electrode and the negative electrode and containing a base composite fiber having bacterial cellulose and chitosan bound to the bacterial cellulose.

Hereinafter, the solid electrolyte and the electrode structure will be described in detail.

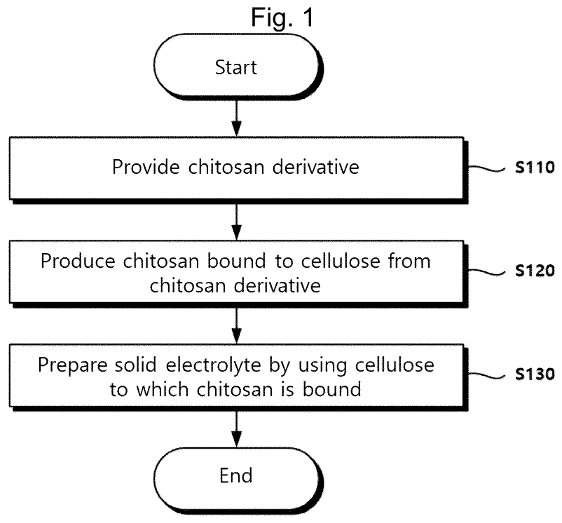

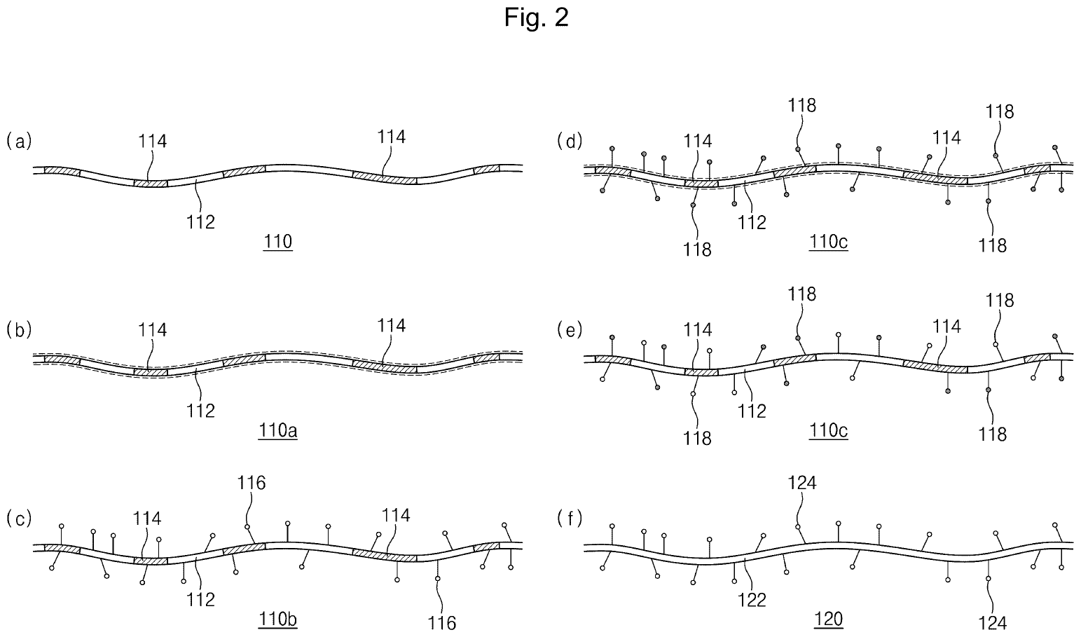

FIG. 1 is a flowchart for explaining a method for preparing a solid electrolyte of an aluminum-air secondary battery according to an embodiment of the present application, and FIG. 2 is views for explaining a solid electrolyte of a metal-air battery according to an embodiment of the present application and a method for preparing the same.

Referring to FIGS. 1 and 2, the method for preparing a solid electrolyte may include: providing a chitosan derivative (S110); preparing chitosan bound to cellulose from the chitosan derivative (S120); and preparing a solid electrolyte by using the cellulose to which the chitosan is bound (S130).

The chitosan derivative may be obtained by mixing a chitosan precursor in a solvent. According to one embodiment, the chitosan derivative may be obtained by adding a solubilizer to chitosan chloride and solvent. Accordingly, the chitosan chloride may be easily dissolved in the solvent, and the chitosan derivative may be easily provided to a medium to be described below, thereby easily preparing a cellulose to which chitosan is bound.

For example, the solvent may be aqueous acetic acid, and the solubilizer may include at least one of glycidyltrimethylammonium chloride, (2-aminoethyl)trimethylammonium chloride, (2-chloroethyl)trimethylammonium chloride, (3-carboxypropyl)trimethylammonium chloride, or (formylmethyl)trimethylammonium chloride.

The chitosan may have excellent thermal and chemical stabilities as well as a high ion conductivity, and may contain OH ions without a long-term loss. In addition, as described below, when used in a metal-air battery, there may be high compatibility with a zinc negative electrode and a compound structure of copper, phosphorus and sulfur.

Alternatively, according to another embodiment, the chitosan derivative may be used as a commercial product.

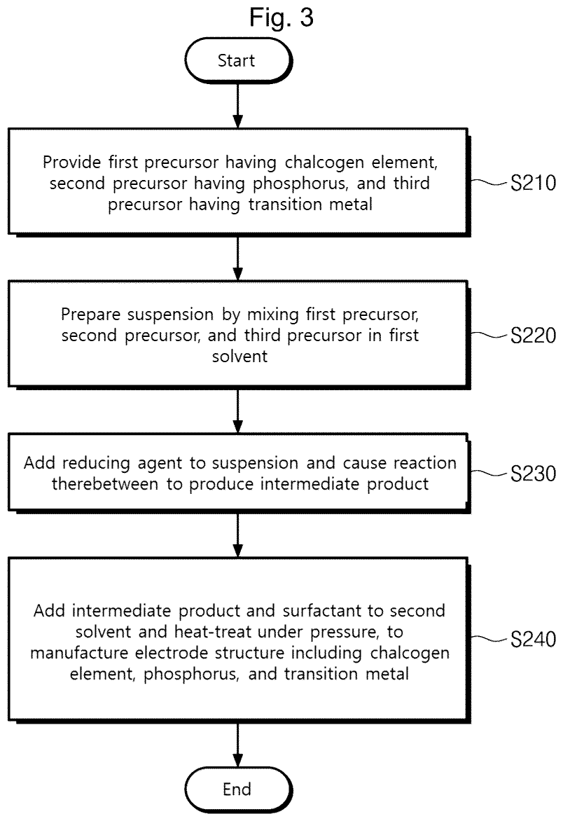

The producing of the cellulose to which the chitosan is bound may include: preparing a culture medium having the chitosan derivative; and injecting and culturing a bacterial strain in the culture medium to produce a base composite fiber 110 including cellulose 112 to which chitosan 114 is bound as shown in (a) of FIG. 3. In this case, the cellulose 112 may be bacterial cellulose.

According to one embodiment, the cellulose 112 to which the chitosan 114 is bound may be prepared by culturing a bacterial pellicle in the culture medium and then desalinating the bacterial pellicle. The bacterial pellicle may be prepared by preparing a culture medium containing the chitosan derivative together with raw materials (for example, pineapple juice, peptone, disodium phosphate, and citric acid) for culturing yeast and bacteria, injecting a strain, and then culturing the same. For example, the strain may be Acetobacter xylinum.

The cultured bacterial pellicle may be washed, dried, desalted with an acidic solution (for example, HCl) and neutralized, and then the solvent may be removed to prepare the base composite fiber 110 including the cellulose 112 to which the chitosan 114 is bound. In the desalting process, the remaining Na, K, or cell shields and debris may be removed to prepare the cellulose 112 to which the chitosan 114 with high purity is bound.

In addition, the chitosan 114 may be chemically bound to the cellulose 112. Accordingly, in the cellulose 112 to which the chitosan 114 is bound, stretchable vibration corresponding to C—N may be observed during XPS analysis.

Unlike the above, according to another embodiment, the cellulose 112 to which the chitosan 114 is bound may be prepared by culturing a bacterial pellicle in the culture medium, washing with an alkali solution to remove unreacted bacterial cells, performing centrifugation and purification with deionized water, and evaporating the solvent. In other words, the desalting process using the acidic solution described above may be omitted.

According to one embodiment, a first composite fiber 110a may be prepared as a surface of the cellulose 112 to which the chitosan 114 is bound, that is, a surface of the base composite fiber 110 is oxidized by using an oxidizing agent.

Specifically, the preparing of the first composite fiber 110a may include: adding the base composite fiber 110 to an aqueous solution containing an oxidizing agent to prepare a source solution; adjusting the pH of the source solution to be basic; adjusting the pH of the source solution to be neutral; and washing and drying the pulp in the source solution to prepare the first composite fiber 110a.

For example, the aqueous solution containing the oxidizing agent may be an aqueous TEMPO solution. Alternatively, as another example, the aqueous solution containing the oxidizing agent may include at least one of 4-hydroxy-TEMPO, (diacetoxyiodo)benzene, 4-amino-TEMPO, 4-carboxy-TEMPO, 4-methoxy-TEMPO, TEMPO methacrylate, 4-acetamido-TEMPO, 3-carboxy-PROXYL, 4-maleimido-TEMPO, 4-hydroxy-TEMPO benzoate, or 4-phosphonooxy-TEMPO.

The source solution may further include a sacrificial reagent and an additional oxidizing agent for the oxidation reaction of the base composite fiber 110. For example, the sacrificial reagent may include at least one of NaBr, sodium iodide, sodium bromate, sodium bromite, sodium borate, sodium chlorite, or sodium chloride, and the additional oxidizing agent may include at least one of NaClO, potassium hypochlorite, lithium hypochlorite, sodium chlorite, sodium chlorate, perchloric acid, potassium perchlorate, lithium perchlorate, tetrabutylammonium perchlorate, zinc perchlorate, hydrogen peroxide, or sodium peroxide.

According to one embodiment, the adjusting of the pH of the source solution to be basic, the pH of the source solution may be adjusted to 10. Accordingly, the oxidation reaction may be easily induced while a precipitate is minimized, and a degree of oxidation of the first composite fiber 110a may be improved as compared to the reaction condition of pH 8-9.

According to one embodiment, after the base composite fiber 110 and the sacrificial reagent are provided to the aqueous solution containing the oxidizing agent, the additional oxidizing agent may be provided. In addition, the additional oxidizing agent may be provided dropwise. Accordingly, an abrupt oxidation phenomenon of the base composite fiber 110 may be prevented, and as a result, the surface of the base composite fiber 110 may be uniformly and stably oxidized.

In addition, according to one embodiment, a second composite fiber 110b may be prepared by binding bromine to the surface of the cellulose 112 to which the chitosan 114 is bound and substituting a first functional group 116 including nitrogen with bromine.

The first functional group 116 may be represented by <Formula 1> below, and the first functional group 116 may be bound to the chitosan 114 and/or the cellulose 112.

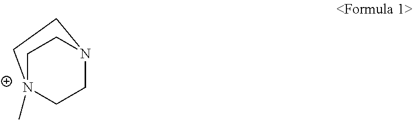

In other words, the second composite fiber 110b may have quaternary N.

Specifically, the preparing of the second composite fiber 110b may include: preparing a first source solution by dispersing the base composite fiber 110 in a first solvent and adding a bromine source; preparing a reaction suspension by adding a coupling agent to the first source solution and causing a reaction therebetween; preparing a brominated base composite fiber by filtering, washing and freeze-drying the reaction suspension; preparing a second source solution by dispersing the brominated base composite fiber in a second solvent; adding a precursor of the first functional group 116 to the second source solution and causing a reaction therebetween; and preparing the second composite fiber 110b by filtering, washing and freeze-drying the reacted solution.

For example, the first solvent and the second solvent may be the same as each other, and may include at least one of N, N-dimethylacetamide, acetamide, acetonitrile, ethanol, ethylenediamine, diethyl ether, or benzaldehyde.

For example, the bromine source may include at least one of LiBr, sodium bromide, or potassium bromide.

For example, the coupling agent may include N-bromosuccinimide and triphenylphosphine. Bromine may be easily bound to a surface of the base composite fiber 110 by the coupling agent. Specifically, bromine in N-bromosuccinimide may be bound to the base composite fiber 110, and triphenylphosphine may reduce a bromine precursor (bromine source or N-bromosuccinimide) to improve a reaction rate.

As described above, after obtaining the base composite fiber brominated in the reaction suspension, the brominated base composite fiber may be freeze-dried. Accordingly, a loss of bromine in the brominated base composite fiber may be minimized, and a secondary reaction of bromine with other elements may be minimized.

For example, a precursor of the first functional group 116 may include 1,4-diazabicyclo[2.2.2]octane.

In addition, according to one embodiment, a third composite fiber 110c in which DNA 118 is bound to a surface of the cellulose 112 to which the chitosan 114 is bound, may be prepared.

The binding of the DNA 118 to the base composite fiber 110 having the cellulose 112 to which the chitosan 114 is bound may include: providing the base composite fiber 110 including the cellulose 112 and the chitosan 114; adding oxidized chitosan to a solvent and mixing with the base composite fiber 110 to prepare a mixture; and adding the DNA 118 to the mixture and causing a reaction therebetween to bind the DNA 118 to a surface of the base composite fiber 110. The DNA 118 may be easily bound to the base composite fiber 110 via the oxidized chitosan. Specifically, the oxidized chitosan and the DNA 118 may be reacted, and then the reactant may be chemically bound to the base composite fiber 110, and the oxidized chitosan may be removed in a washing process.

According to one embodiment, the base composite fiber 110 may include the first composite fiber 110a that is formed as a surface of the base composite fiber 110 is oxidized and/or the second composite fiber 110b that is formed as the first functional group 116 is bound to a surface of the base composite fiber 110. In other words, as shown in (d) of FIG. 1, the DNA 118 may be bound to the first composite fiber 110a described with reference to (b) of FIG. 1 or to the surface of the second composite fiber 110b described with reference to (c) of FIG. 1. In other words, the third composite fiber 110c to which the DNA 118 is bound may be formed by binding the DNA 118 to at least one of the base composite fiber 110, the first composite fiber 110a, and the second composite fiber 110b. A low-temperature operation property of a solid electrolyte may be improved by the DNA 118.

In addition to the DNA 118, a carboxyl group or a DABCO group may be further bound to the surface of the third composite fiber 110c.

As described above, a solid electrolyte may be prepared using the cellulose 112 to which the chitosan 114 is bound (S130).

The solid electrolyte may be prepared in the form of a membrane M in which the base composite fiber 110 including the cellulose 112 to which the chitosan 114 is bound forms a network. Accordingly, the solid electrolyte may have a plurality of pores provided therein, may have a high surface area, and may have excellent flexibility and mechanical property.

The solid electrolyte may be in a state in which a crystalline phase and an amorphous phase are mixed. More specifically, the solid electrolyte may have a ratio of an amorphous phase higher than a ratio of a crystalline phase. Accordingly, the solid electrolyte may have a high ionic mobility.

In addition, when the solid electrolyte is mounted on a metal-air battery, the metal-air battery may smoothly perform charge/discharge operations at low and high temperatures. In other words, the metal-air battery including the solid electrolyte according to an embodiment of the present application may smoothly operate at low and high temperatures, have a wide range of operating temperatures, and be used in various environments.

According to one embodiment, the solid electrolyte may be prepared by a gelatin process using the first composite fiber 110a and the second composite fiber 110b. In this case, the solid electrolyte may include the first composite fiber 110a and the second composite fiber 110b, in which the first composite fiber 110a and the second composite fiber 110b may be cross-linked to each other. Due to the first composite fiber 110a, the number of OH ions in the solid electrolyte may be increased, ionic conductivity may be improved, a negative charge density may be increased, and swelling resistance may be improved. In addition, due to the second composite fiber 110b, thermal stability may be improved due to an increase in molecular weight, ion exchange capacity may be improved to have a high moisture impregnation rate and a high swelling resistance, cross-linking binding strength with the first composite fiber 110a may be improved, and ion discerning selectivity with a specific solvent may be selectively high. Accordingly, a secondary battery including the solid electrolyte may have improved a charge/discharge property and a life property.

Specifically, the preparing of the solid electrolyte may include: mixing the first composite fiber 110a and the second composite fiber 110b with a solvent to prepare a mixed solution; adding a crosslinking agent and an initiator to the mixed solution and causing a reaction therebetween to prepare a suspension; casting the suspension on a substrate and drying the same to prepare a composite fiber membrane; and performing an ion exchange process on the composite fiber membrane.

For example, the solvent may include a mixed solvent of methylene chloride, 1,2-propanediol, and acetone, the crosslinking agent may include glutaraldehyde, and the initiator may include N,N-diethyl-N-methyl-N-(2-methoxyethyl) ammonium bis(trifluoromethanesulfonyl)imide.

In addition, for example, an ion exchange process for the composite fiber membrane may include providing a KOH aqueous solution and a ZnTFSI aqueous solution to the composite fiber membrane. Accordingly, the content of OH ions in the solid electrolyte may be improved.

As described above, according to an embodiment of the present application, the solid electrolyte may include the membrane including at least one of the base composite fiber 110, the first composite fiber 110a, or the second composite fiber 110b.

A ratio of the chitosan 114 in the solid electrolyte may be easily controlled according to a content of the chitosan derivative provided in the culture medium. The crystallinity, ionic conductivity, and swelling ratio of the solid electrolyte may be controlled according to a ratio of the chitosan 114. Specifically, as the ratio of the chitosan 114 increases, the crystallinity of the solid electrolyte may gradually decrease.

According to one embodiment, the content of the chitosan 114 may be greater than 30 wt % and less than 70 wt %. If the content of the chitosan 114 is equal to or less than 30 wt % or equal to or greater than 70 wt %, the ionic conductivity of the solid electrolyte may be remarkably reduced, and the swelling ratio may be remarkably increased.

However, according to an embodiment of the present application, the ratio of the chitosan 114 in the solid electrolyte may be greater than 30 wt % and less than 70 wt %, and thus the solid electrolyte may have a low swelling ratio value while a high ionic conductivity property is maintained.

Alternatively, according to another embodiment, the solid electrolyte may be prepared using the third composite fiber 110c. Specifically, the solid electrolyte may be prepared by a method of mixing the third composite fiber (110c, for example, the first composite fiber 110a to which the DNA 118 is bound and/or the second composite fiber 110b to which the DNA 118 is bound) with a solvent, casting the solvent mixed with the third composite fiber 110c onto a substrate, drying the same to prepare a composite fiber membrane, and performing an ion exchange process (for example, ion exchange at room temperature at 1 M KOH aqueous solution and 0.1 M ZnTFSI for six hours, respectively) on the composite fiber membrane.

Alternatively, according to another embodiment, the functional fiber 120 shown in (f) of FIG. 1 may be added to the solid electrolyte including at least one of the base composite fiber 110, the first composite fiber 110a, the second composite fiber 110b, or the third composite fiber 110c.

The functional fiber 120 may have piperidone 122 as a backbone, and a terphenyl group 124 may be bound to a surface of the functional fiber 120.

The preparing of the solid electrolyte to which the functional fiber 120 is further added may include a method of mixing at least one of the base composite fiber 110, the first composite fiber 110a, the second composite fiber 110b, and the third composite fiber 110c with the functional fiber 120 in a solvent, casting the mixed solvent on a substrate, drying the same to prepare a composite fiber membrane, and performing an ion exchange process on the composite fiber membrane.

The functional fiber 120 may be further added to the solid electrolyte, thereby improving a high temperature operation property of the solid electrolyte as described below.

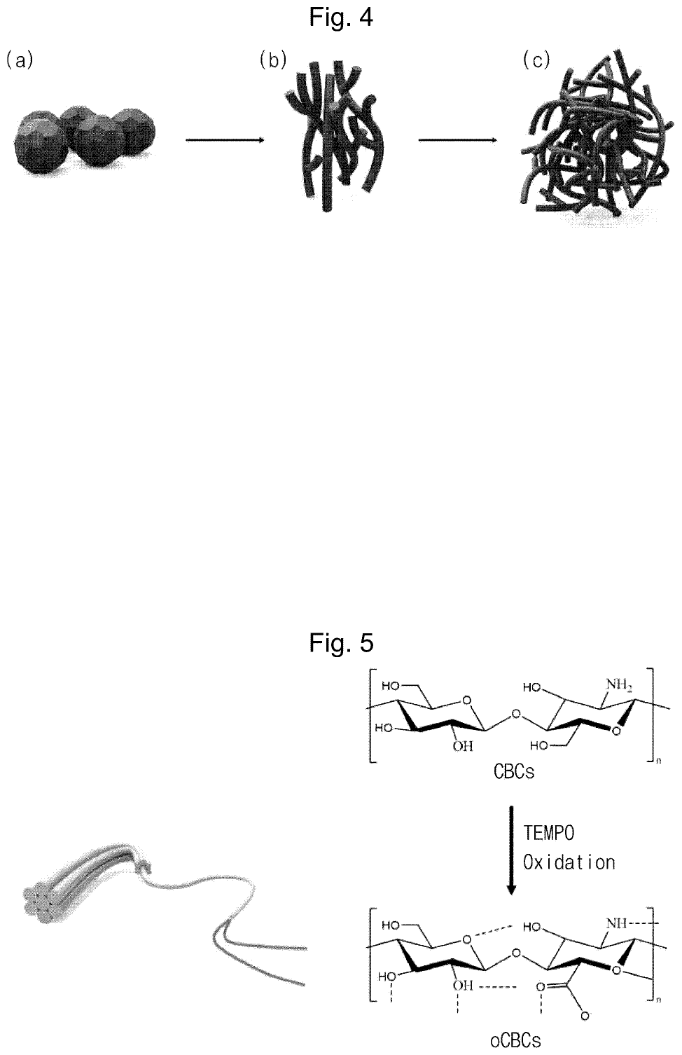

Subsequently, an electrode structure for a positive electrode of an aluminum-air secondary battery and a method for manufacturing the same will be described with reference to FIGS. 3 and 4.

FIG. 3 is a flowchart for explaining a method for manufacturing an electrode structure for a positive electrode of an aluminum-air secondary battery according to an embodiment of the present application, and FIG. 4 is a view for explaining a process of manufacturing an electrode structure for a positive electrode of an aluminum-air battery according to an embodiment of the present application.

Referring to FIGS. 3 and 4, a first precursor having a chalcogen element, a second precursor having phosphorus, and a third precursor having a transition metal may be prepared (S210).

According to one embodiment, the chalcogen element may include sulfur. In this case, for example, the first precursor may include at least one of dithiooxamide, dithiobiuret, dithiouracil, acetylthiourea, thiourea, N-methylthiourea, bis(phenylthio)methane, 2-imino-4-thiobiuret, N,N′ammonium sulfide, methyl methanesulfonate, sulfur powder, sulphates, N,N-dimethylthioformamide, Davy reagent methyl, sodium sulfide, thioacetamide, or sodium thiophosphate.

Alternatively, according to another embodiment, the chalcogen element may include at least one of oxygen, selenium, or tellurium.

For example, the second precursor may include at least one of tetradecylphosphonic acid, ifosfamide, octadecylphosphonic acid, hexylphosphonic acid, trioctylphosphine, phosphorus acid, triphenylphosphine, ammonium phosphide, pyrophosphates, Davy reagent methyl, cyclophosphamide monohydrate, phosphorus trichloride, phosphorus(V) oxychloride, thiophosphoryl chloride, phosphorus pentachloride, phosphorus pentasulfide, ifosfamide, triphenylphosphine, or sodium thiophosphate.

According to one embodiment, different heterogeneous types including phosphorus may be used as the second precursor. For example, a mixture of tetradecylphosphonic acid and ifosfamide at a ratio of 1:1 (M %) may be used as the second precursor. Accordingly, a stoichiometric ratio of the transition metal, phosphorus, and the chalcogen element may be controlled to 1:1:1. As a result, as will be described later, the positive electrode according to an embodiment of the present application may have a covellite structure, and the electrochemical properties of the positive electrode may be improved.

Alternatively, according to another embodiment, unlike the above, ifosfamide may be used alone, or phosphorus acid may be used alone as the second precursor.

According to one embodiment, the transition metal may include copper. In this case, for example, the third precursor may include at least one of copper chloride, copper(II) sulfate, copper(II) nitrate, copper selenide, copper oxychloride, cupric acetate, copper carbonate, copper thiocyanate, copper sulfide, copper hydroxide, copper naphthenate, or copper(II) phosphate.

Alternatively, according to another embodiment, the transition metal may include at least one of magnesium, manganese, cobalt, iron, nickel, titanium, zinc, calcium, aluminum, or tin.

The third precursor including the transition metal may include at least one of a transition metal chloride, a transition metal sulfide, or a transition metal nitride.

According to one embodiment, a bifunctional activity, which is a difference value between overpotentials of ORR and OER of the electrode structure to be described later, may be controlled by a type of the first precursor, a type of the second precursor, and a type of the transition metal of the third precursor.

A suspension may be prepared by mixing the first precursor, the second precursor, and the third precursor in a first solvent.

According to one embodiment, the first solvent may include at least one of alcohol (for example, ethanol, methanol, propanol, butanol, pentanol, etc.), DMF, oleic acid, oleylamine, 1-octadecene, trioctylphosphine, ethylenediamine, pyrrolidone, tributylamine, amine-based solvent, or deionized water.

According to one embodiment, a direction of crystal plane of the electrode structure to be described later may be controlled according to a type of the solvent and a mixing ratio. In other words, according to the type of the solvent and the mixing ratio, whether a crystal plane 101 is developed or not in the electrode structure may be controlled, and thus a bifunctional activity value, which is the electrochemical property of the electrode structure, may be controlled.

According to one embodiment, the solvent may be selected (for example, mixing ethanol and ethylenediamine at a volume ratio of 1:3) so that the crystal plane 101 may be developed in the electrode structure, thereby improving the electrochemical properties (for example, ORR, OER, HER) of the electrode structure.

Subsequently, referring to FIG. 1, an intermediate product may be produced by adding a reducing agent to the suspension and causing a reaction therebetween (S130).

For example, the reducing agent may include at least one of ammonium hydroxide, ammonium chloride, or tetramethylammonium hydroxide.

After the first precursor, the second precursor, and the third precursor are mixed in the solvent, the reducing agent may be provided to perform nucleation and crystallization as shown in (a) of FIG. 4 and prepare an intermediate including a plurality of stems as shown (b) of FIG. 4.

According to one embodiment, the suspension may be heat-treated to form the intermediate product. For example, the mixture to which the reducing agent is added may be heat treated under reflux at 120° C., and then washed with deionized water and ethanol.

The reducing agent may maintain pH and increase a reaction rate while performing a function of the reducing agent during heat treatment. Accordingly, the intermediate product having the plurality of stems may be easily prepared. For example, when the transition metal is copper and the chalcogen element is sulfur, the intermediate structure may be CuPS having a covellite crystal structure.

Alternatively, according to another embodiment, the intermediate product may be prepared by a method of adding the reducing agent to the suspension and then stirring the suspension at room temperature. In other words, the intermediate product may be prepared by a method of stirring at room temperature without an additional heat treatment.

An electrode structure including the chalcogen element, the phosphorus, and the transition metal may be prepared by a method of adding a surfactant to the intermediate product and performing heat treatment under pressure (S140).

According to one embodiment, the intermediate product and the surfactant may be added to a second solvent, and then a pressure heat treatment process may be performed.

The second solvent may be the same as the first solvent. For example, the second solvent may include at least one of alcohol (for example, ethanol, methanol, propanol, butanol, pentanol, etc.), DMF, oleic acid, oleylamine, 1-octadecene, trioctylphosphine, ethylenediamine, pyrrolidone, tributylamine, amine-based solvent, or deionized water.

For example, the surfactant may include at least one of Triton X-165, Triton X-100, H2SO4, HCl, hexamethylenetetramine, hexadecyltrimethylammonium bromide, ammonium sulfate, polyoxyethylene, dodecanol, tridecane, or stearic acid.

According to one embodiment, a bifunctional activity, which is a difference value between overpotentials of ORR and OER of the electrode structure, may be controlled by a type of the second precursor and a type of the surfactant.

Alternatively, according to one embodiment, a chalcogen element source having the chalcogen element may be further added along with the reducing agent. Accordingly, the chalcogen element lost in the reaction process may be supplemented by the chalcogen element source, and the electrode structure having a sponge structure in which a plurality of fibrillated fibers to be described later form a network may be easily formed.

For example, when the chalcogen element is sulfur, the chalcogen element source may include at least one of sodium bisulfite, sodium sulfate, sodium sulfide, sodium thiosulfate, sodium thiomethoxide, sodium ethanethiolate, or sodium methanethiolate.

In addition, according to one embodiment, a phosphorus source may be also added together with the chalcogen element source.

According to one embodiment, a process of mixing the intermediate product and the surfactant in the second solvent may be performed in a cooled state. The reaction rate may be prevented from excessively increasing due to the heat generated in the process of adding the second reducing agent, thereby improving the electrochemical properties of the electrode structure to be described later.

As described above, a plurality of branches may branch off from the plurality of stems as shown in (c) of FIG. 2 by adding the surfactant to the intermediate product and performing heat treatment under pressure, and thus the electrode structure having a sponge structure in which a plurality of fibrillated fibers form a network may be formed.

The electrode structure having a sponge structure may be immersed in liquid nitrogen after being washed with deionized water and ethanol. Accordingly, mechanical properties and flexibility of the electrode structure having a sponge structure may be improved. Alternatively, the process of immersing in liquid nitrogen may be omitted.

In addition, after being immersed in liquid nitrogen, the electrode structure having a sponge structure may be freeze-dried, and the remaining solvents may be removed to minimize a secondary reaction.

The electrode structure may include a membrane having a sponge structure, in which a plurality of fibrillated fibers having a plurality of branches branched off from the plurality of stems form a network as described above. Accordingly, the electrode structure may have a porous structure in which a plurality of pores having a size of 1 to 2 nm are provided, and may be flexible.

In addition, according to one embodiment, as described above, the type and ratio of the solvent mixed with the first precursor, the second precursor, and the third precursor may be controlled and thus a crystal plane 101 may be developed in the electrode structure. Accordingly, upon the XRD analysis of the electrode structure, a peak value corresponding to the crystal plane 101 may have a maximum value compared with a peak value corresponding to another crystal plane. Upon the XRD measurement, a peak value corresponding to the crystal plane 101 may be observed in a range of 20 values of 19° to 21°.

The plurality of fibers forming the electrode structure may include a compound of the transition metal, phosphorus, and the chalcogen element. For example, when the transition metal is copper and the chalcogen element is oxygen, the fiber may be represented by the following <Formula 1>.

CuPₓS_{y} <Formula 1>

When the fiber forming the electrode structure is represented as above <Formula 1>, it may be x+y=1, 0.3≤x≤0.7, 0.3≤y≤0.7.

If, in above <Formula 1>, x is less than 0.3 or more than 0.7 and y is less than 0.3 or more than 0.7, ORR, OER, and HER properties of the electrode structure may be deteriorated, and thus the electrode structure may not react reversibly in a process of charging and discharging a metal-air battery including the electrode structure as a positive electrode, accordingly.

However, according to an embodiment of the present application, when the electrode structure is represented by CuPₓS_{y}, a composition ratio of P may be 0.3 or more and 0.7 or less and a composition ratio of S may be 0.3 or more and 0.7 or less. Accordingly, the ORR, OER, and HER properties of the electrode structure may be improved, and the charge/discharge property and life property of a metal-air battery, which includes the electrode structure as the positive electrode, may be improved.

When the metal-air battery including the electrode structure as a positive electrode performs charging and discharging, a lattice spacing of the fibers included in the electrode structure may be reversibly changed. Specifically, when the metal-air battery is charged, the lattice spacing may be 0.478 nm, and when the metal-air battery is discharged, the lattice spacing may be 0.466 nm. The lattice spacing of the fibers may be confirmed by the HRTEM.

According to an embodiment of the present application, the electrode structure having a membrane form in which the plurality of fibrillated fibers form a network according to a method of mixing the first precursor having the chalcogen element, the second precursor having phosphorus, and the third precursor having the transition metal, adding the reducing agent, and heat treating under pressure.

Accordingly, the electrode structure having high electrochemical properties may be manufactured by an inexpensive method.

In addition, the electrode structure may be manufactured by stirring and heat treating under pressure, and thus may be easily mass-produced and subjected to a simple manufacturing process, thereby providing the electrode structure for a positive electrode of a metal-air battery.

Hereinafter, a specific experimental example of the solid electrolyte of the metal-air battery of the present application, and results of evaluating properties will be described accordingly.

Preparing of base composite fiber (CBC) according to Experimental Example 1-1

Acetobacter xylinum was provided as a bacterial strain, and a chitosan derivative was provided. The chitosan derivative was prepared by dissolving 1 g of chitosan chloride in 1% (v/v) aqueous acetic acid, treating the resulting suspension with 1 M glycidyltrimethylammonium chloride at 65° C. for 24 hours in an N2 atmosphere, precipitating, and filtering multiple times with ethanol.

A Hestrin-Schramm (HS) culture medium containing pineapple juice (2% w/v), yeast (0.5% w/v), peptone (0.5% w/v), disodium phosphate (0.27% w/v), citric acid (0.015% w/v), and the chitosan derivative (2% w/v) was prepared and steam-sterilized at 121° C. for 20 minutes. In addition, Acetobacter xylinum was activated in a pre-cultivation Hestrin-Schramm (HS) culture medium at 30° C. for 24 hours, and then acetic acid was added to maintain pH 6.

After that, Acetobacter xylinum was cultured in the Hestrin-Schramm (HS) culture medium at 30° C. for seven days.

The harvested bacterial pellicle was washed with deionized water to neutralize the pH of the supernatant and dehydrated in vacuum at 105° C. The resulting cellulose was demineralized by using 1 N HCl for 30 minutes (a mass ratio of 1:15, w/v) to remove an excessive amount of reagent, and then was purified a plurality of times by centrifugation with deionized water until the supernatant reached a neutral pH. Finally, all solvents were evaporated at 100° C. to prepare a base composite fiber (chitosan-bacterial cellulose (CBC)).

Preparing of First Composite Fiber (oCBC) According to Experimental Example 1-2

A first composite fiber (TEMPO-oxidized CBC (oCBCs)) that is formed as a surface of the base composite fiber is oxidized according to Experimental Example 1-1 was designed according to a method for conjugating a base composite fiber (CBC) of hydroxymethyl and ortho-para directing acetamido to an oxide of TEMPO by an oxidation reaction using 2,2,6,6-tetramethylpiperidin-1-oxyl (TEMPO), sodium bromide (NaBr) and sodium hypochlorite (NaClO) as shown in FIG. 5.

Specifically, 2 g of the base composite fiber dispersed in a 2 mM TEMPO aqueous solution was reacted with NaBr (1.9 mM). 5 mM NaClO was used as an additional oxidizing agent.

The reaction suspension was stirred with ultrasonic waves and subjected to a reaction at room temperature for three hours. The pH of the suspension was maintained at 10 by successive addition of 0.5M NaOH solution. Then, 1N HCl was added to the suspension to keep the pH neutral for three hours. The oxidized pulp produced in the suspension was washed three times with 0.5 N HCl, and the supernatant was brought to a neutral pH with deionized water.

The washed pulp was exchanged with acetone and toluene for 30 minutes and dried to evaporate the solvent, and finally a first composite fiber (oCBC) fiber was obtained.

As can be understood from FIG. 5, the surface of the base composite fiber may be oxidized.

Preparing of Second Composite Fiber (qCBC) According to Experimental Example 1-3

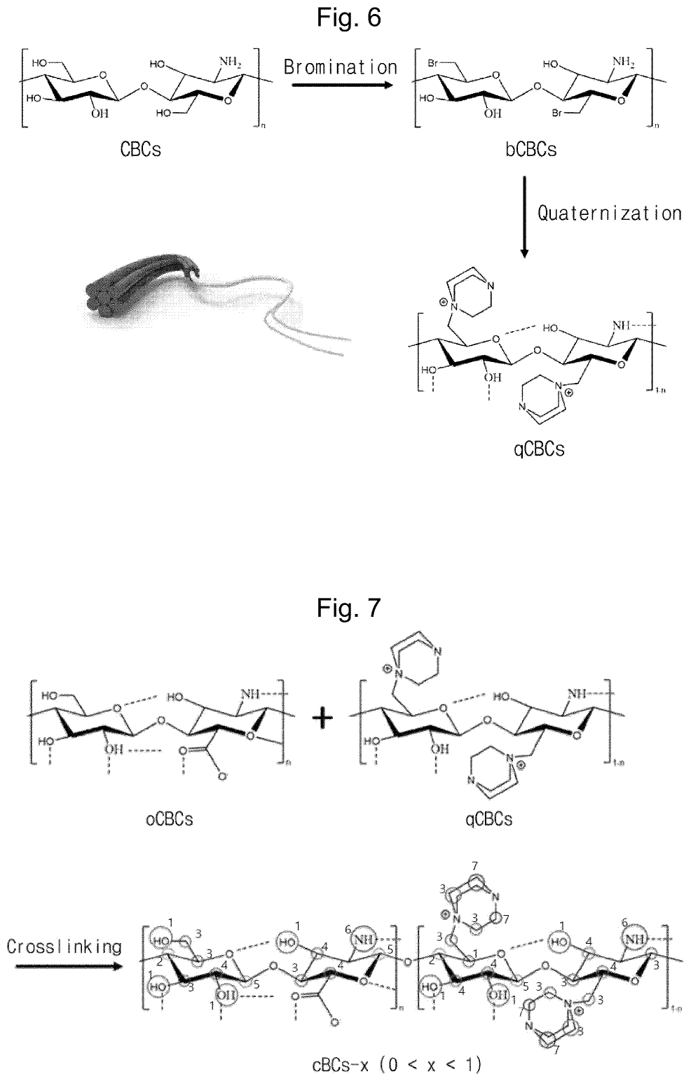

A second composite fiber (covalently quaternized CBC (qCBC)) that is formed as a first functional group having nitrogen is bound to the base composite fiber according to Experimental Example 1-1, was prepared according to a method for conjugating a brominated base composite fiber (CBC) and a quaternary amine group by a coupling agent using 1,4-diazabicyclo[2.2.2]octane, as shown in FIG. 6.

Specifically, 1 g of the base composite fiber dispersed in N,N-dimethylacetamide (35 ml) solution was reacted with LiBr (1.25 g) suspension while being stirred for 30 minutes. N-bromosuccinimide (2.1 g) and triphenylphosphine (3.2 g) were used as a coupling agent. The two reaction mixtures were stirred for 10 minutes and reacted at 80° C. for 60 minutes.

Then, the reaction suspension was cooled to room temperature, added to deionized water, filtered, rinsed with deionized water and ethanol, and freeze-dried to obtain a brominated base composite (bCBC) fiber.

The brominated base composite fiber was dissolved in 100 ml of N,N-dimethylformamide, and reacted with 1.2 g of 1,4-diazabicyclo[2.2.2]octane.

After that, the mixture was subjected to ultrasonic treatment for 30 minutes, and then reacted at room temperature for 24 hours. The resulting solution was mixed with diethyl ether, washed five times with diethyl ether/ethyl acetate, and freeze-dried to obtain a second composite fiber (covalently quaternized CBC (qCBC)).

As can be understood from FIG. 6, it can be confirmed that the first functional group having nitrogen is bound to the surface of the base composite fiber.

Preparing of Solid Electrolyte (CBCs) According to Experimental Example 1-4

A solid electrolyte was prepared by a gelatin process using the first composite fiber (oCBC) according to Experimental Example 1-2 and the second composite fiber (qCBC) according to Experimental Example 1-3, as shown in FIG. 7. Specifically, the first composite fiber (oCBC) and the second composite fiber (qCBC) were dissolved in a mixture of methylene chloride, 1,2-propanediol and acetone (8:1:1 v/v/v %) at the same weight ratio by using ultrasonic waves, and then 1 wt % of glutaraldehyde as a crosslinking agent and 0.3 wt % of N,N-diethyl-N-methyl-N-(2-methoxyethyl) ammonium bis(trifluoromethanesulfonyl)imide as an initiator were added.

A vacuum chamber (200 Pa) was used to remove air bubbles from the gel suspension and cast on glass at 60° C. for six hours. A composite fiber membrane was peeled off while being coagulated with deionized water, rinsed with deionized water, and vacuum dried.

Solid electrolyte (CBCs) were prepared through ion exchange with 1 M KOH aqueous solution and 0.1 M ZnTFSI at room temperature for six hours, respectively. After that, washing and immersion processes were performed with deionized water in an N₂ atmosphere in order to avoid a reaction with C02 and a carbonate formation.

As can be understood from FIG. 7, it can be confirmed that the first composite fiber (oCBC) and the second composite fiber (qCBC) are cross-linked to each other to form the solid electrolyte (CBCs).

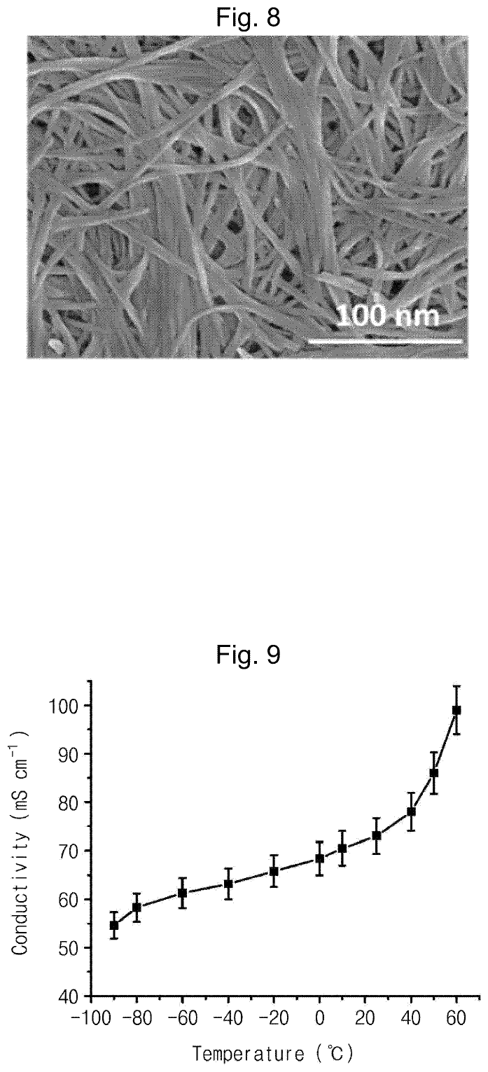

FIG. 8 is a view showing an SEM picture of a solid electrolyte prepared according to Experimental Example 1-4 of the present application.

Referring to FIG. 8, an SEM picture was taken of the solid electrolyte prepared according to Experimental Example 1-4 as described above.

As can be understood from FIG. 8, it can be confirmed that a plurality of pores exist inside, and it can be confirmed that the bacterial cellulose fiber to which chitosan is bound is provided in a fibrillated form and a diameter is 5-10 nm.

It can be seen that a measured pore size is about 20-200 nm and the bacterial cellulose fiber to which chitosan is bound in the solid electrolyte forms a network with a high pore and a high surface area, thereby having a high strength against swelling.

Preparing of Base Composite Fiber (CBC) According to Experimental Example 1-5

Acetobacter xylinum was provided as a bacterial strain, and a chitosan derivative was provided.

A Hestrin-Schramm (HS) culture medium containing pineapple juice (2% w/v), the chitosan derivative (2% w/v) and a nitrogen source (Daejeong X by Kisan Bio Co.) was prepared and Acetobacter xylinum was cultured in the Hestrin-Schramm (HS) culture medium at 30° C. for seven days.

The harvested bacterial pellicle was washed with water, washed with an alkali solution at room temperature to remove unreacted bacterial cells, and purified by centrifugation multiple times using deionized water. Finally, a remaining solvent was evaporated at 100° C. to prepare a base composite fiber (chitosan-bacterial cellulose (CBC)) according to Experimental Example 1-5.

Preparing of First Composite Fiber (oCBC) According to Experimental Example 1-6

A first composite fiber (oCBC) according to Experimental Example 1-6 was prepared by performing the same process as in the first composite fiber (oCBC) according to Experimental Example 1-2, but using the base composite fiber according to Experimental Example 1-5 instead of the base composite fiber according to Experimental Example 1-1.

Preparing of Second Composite Fiber (qCBC) According to Experimental Example 1-7

A second composite fiber (qCBC) according to Experimental Example 1-7 was prepared by performing the same process as in the second composite fiber (qCBC) according to Experimental Example 1-3, but using the base composite fiber according to Experimental Example 1-5 instead of the base composite fiber according to Experimental Example 1-1.

Preparing of Third Composite Fiber (DNA-CBC) According to Experimental Example 1-8

An enzyme solution containing an MES buffer of pH 5.7-6, cellulase R10, macerozyme R10, mannitol and KCl was prepared, and Cucumis sativus or Eruca sativa fragments were provided to the enzyme solution, and then the resulting mixture was infiltrated under vacuum in the dark for 30 minutes and decomposed at room temperature for three hours. After that, the resulting solution was diluted with an MMG solution (mannitol+MgCl2+MES, pH 5.7), and then the undecomposed material was purified using a stainless steel mesh, and centrifuged to obtain an extract. Additionally using an MMG solution, the obtained extract was dispersed again in the MMG solution and precipitated to extract pDNA.

A suspension was prepared by treating the extracted pDNA at a ratio of 3:1 to 3:4 w/w for six hours at room temperature using Alexa Fluor 488, and the resulting suspension was dialyzed for three days with deionized water using a 100 kDa MWCO dialysis membrane to remove free dye molecules, and finally centrifuged to stain pDNA. It is a process of staining pDNA with a fluorescent dye to further identify the presence or absence of cross coupling reaction of pDNA, and the process may be omitted.

Chitosan was oxidized with sodium hydroxide and deacetylated under N2 at 90° C. for eight hours, and then the resulting product was washed with deionized water several times and dried under vacuum to produce oxidized chitosan. A suspension was prepared by mixing 2 g of oxidized chitosan, 1 g of the first and second composite fibers (0.5 g of the first composite fiber and 0.5 g of the second composite fiber) per 100 ml of a solvent including 0.3% acetic acid.

The prepared suspension was mixed with the treated pDNA, stirred at room temperature for six hours, and dialyzed to remove unreacted materials, thereby preparing a third composite fiber (DNA-CBC) that is formed as DNA was coupled to the first composite fiber (oCBC) and the second composite fiber (qCBC).

After that, a covalent bond by conjugation of an amino group of chitosan with the first composite fiber (oCBC) and the second composite fiber (qCBC) by amide coupling was performed using N-ethyl-N′-(3-dimethylaminopropyl)-carbodiimide (EDC, 5 mg/ml) and N-hydroxysulfosuccinimide (sulfo-NHS, 5 mg/ml) to strengthen the bonding between DNA and cellulose of the first and second composite fibers (oCBC and qCBC), thereby improving durability.

Then, the reaction product was stirred at 30° C. for 16 hours, cooled, dialyzed and centrifuged, after which the third composite fiber (DNA-CBC) was added to DMSO, cast on a glass substrate, peeled off, and ion-exchanged using an aqueous 1 M KOH solution and 0.1 M ZnTFSI to prepare a solid electrolyte containing the third composite fiber (DNA-CBC).

Preparing of Functional Fiber According to Experimental Example 1-9

N-methyl-4-piperidone serving as a backbone of a polymer, 2,2,2-trifluoroacetophenone as a reaction catalyst, and p-terphenyl as a functional group were mixed with dichloromethane to prepare a mixture.

Trifluoroacetic acid as a reaction initiator and trifluoromethanesulfonic acid as a reaction rate controlling agent were added to the mixture in ice bath, and reacted for 24 hours to prepare a reaction product in which a p-terphenyl functional group was bound to piperidone, dispersed in ethanol, and then the prepared white precipitate was filtered, washed with water, and treated at 50° C. for 12 hours using K2CO3.

The resulting precipitate was washed with water and vacuum dried at 60° C. overnight, and the resulting product was suspended in DMSO and methyl iodide at room temperature for 12 hours. The suspension was poured into diethyl ether, washed with diethyl ether, and vacuum dried at 60° C., thereby preparing a functional fiber including piperidone.

A mixture of the first composite fiber (oCBC) according to Experimental Example 1-6 and the second composite fiber (qCBC) according to Experimental Example 1-7, and the dried product were dissolved in DMSO, cast on a glass plate, and peeled off with deionized water to prepare a solid electrolyte including the functional fiber according to Experimental Example 2-9. After that, the membrane was ion-exchanged at 1 M KOH, washed with DI water, and dried.

FIG. 9 is a view showing results of measuring an ionic conductivity of a solid electrolyte including a third composite fiber according to Experimental Example 1-8 of the present application depending on a temperature.

Referring to FIG. 9, with regard to the solid electrolyte including the third composite fibers according to Experimental Example 1-8 of the present application, the ionic conductivity for OH ions was measured while a temperature was changed between −90° C. and 60° C.

As can be understood from FIG. 9, it was confirmed that the solid electrolyte prepared using the third composite fiber including DNA maintains a high ionic conductivity between −90° C. and 60° C. In conclusion, it can be seen that preparing a solid electrolyte using the third composite fiber including DNA is an efficient method of improving a low-temperature operation property of the solid electrolyte.

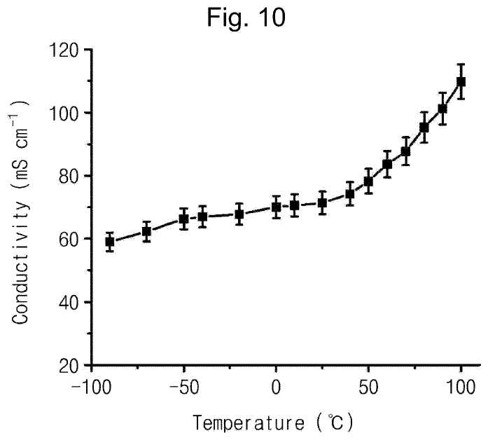

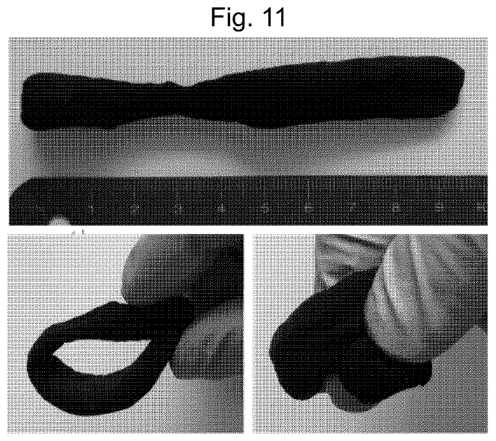

FIG. 10 is a view showing results of measuring an ionic conductivity of a solid electrolyte including a functional fiber according to Experimental Example 1-9 of the present application depending on a temperature.

Referring to FIG. 10, with regard to the solid electrolyte including the functional fiber according to Experimental Example 1-9 of the present application, the ionic conductivity for OH ions was measured while a temperature was changed between −90° C. and 100° C.

As can be understood from FIG. 10, it can be confirmed that the solid electrolyte prepared using the functional fiber including piperidone maintains a high ionic conductivity between −90° C. and 100° C. In conclusion, it can be seen that preparing a solid electrolyte using the functional fiber including piperidone is an efficient method of improving a high-temperature operation property of the solid electrolyte.

Manufacturing of Electrode Structure for Positive Electrode and Secondary Battery According to Experimental Example 2-1

Dithiooxamide was prepared as a first precursor having sulfur, a mixture of tetradecylphosphonic acid and ifosfamide (1:1 M %) was prepared as a second precursor having phosphorus, copper chloride was prepared as a third precursor having copper, and a mixture of ethanol and ethylenediamine (1:3 v/v %) was prepared as a solvent.

The first to third precursors were added to the solvent and stirred to prepare a suspension.

After that, 2.5 M % ammonium hydroxide was added as a reducing agent, stirred for two hours, and heat treated at 120° C. for six hours, after which an intermediate product was obtained, washed with deionized water and ethanol, and dried under vacuum at 50° C.

In an ice bath, the intermediate product was mixed and stirred in 20 ml of deionized water with Triton X-165 as a surfactant and sodium bisulfite as an sulfur element source. After that, the resulting mixture was heat treated under pressure at 120° C. for 24 hours and mixed in M-methyl-pyrrolidone to prepare a slurry, which was then coated and peeled off, thereby preparing a membrane in which a plurality of fibrillated fibers formed of a compound of copper, phosphorus and sulfur form a network.

The membrane was washed with deionized water and ethanol to adjust to neutral pH, stored at −70° C. for two hours, immersed in liquid nitrogen, and freeze-dried in vacuum, so as to prepare a CuPS electrode structure according to Experimental Example 3 in which a crystal plane 101 is developed.

In the process of manufacturing the electrode structure according to Experimental Example 2-1, a ratio of the first precursor having sulfur and the second precursor having phosphorus was controlled to adjust a ratio of P and S in CuPS at 0.1:0.9, 0.2:0.8, 03:0.7, 0.5:0.5, 0.7.0.3, and 0.9:0.1, respectively.

FIG. 11 is a view showing pictures of an electrode structure manufactured according to Experimental Example 2-1 of the present application.

Referring to FIG. 11, the electrode structure (CuP_{0.5}S_{0.5}) manufactured according to Experimental Example 2-1 described above was photographed.

As shown in FIG. 11, it can be confirmed that the electrode structure according to Experimental Example 2-1 has a length of about 10 cm and is flexible.

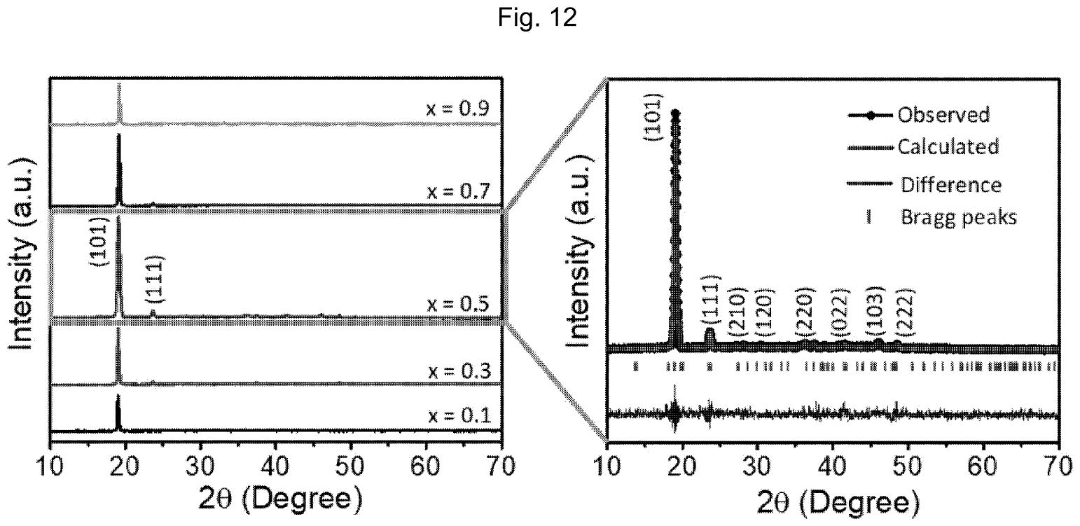

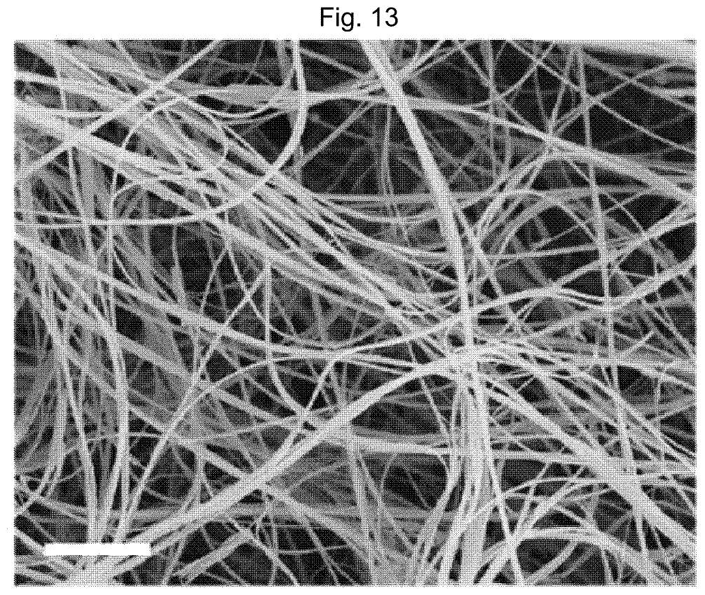

FIG. 12 is an XRD graph of an electrode structure manufactured according to Experimental Example 2-1 of the present application.

Referring to FIG. 12, an XRD measurement was performed for a CuPS electrode structure having various P and S composition ratios according to Experimental Example 2-1.

As can be confirmed from FIG. 12, it can be confirmed that a pattern changes according to a composition ratio of P and S in the CuPS electrode structures according to Experimental Example 2-1, and it can be seen that a size of a peak corresponding to the crystal plane 101 is larger than a size of a peak corresponding to another crystal plane.

In addition, it can be seen that the CuPS positive electrode of Experimental Example 2-1 has a covellite phase with an orthorhombic crystal structure Pnm21 space group.

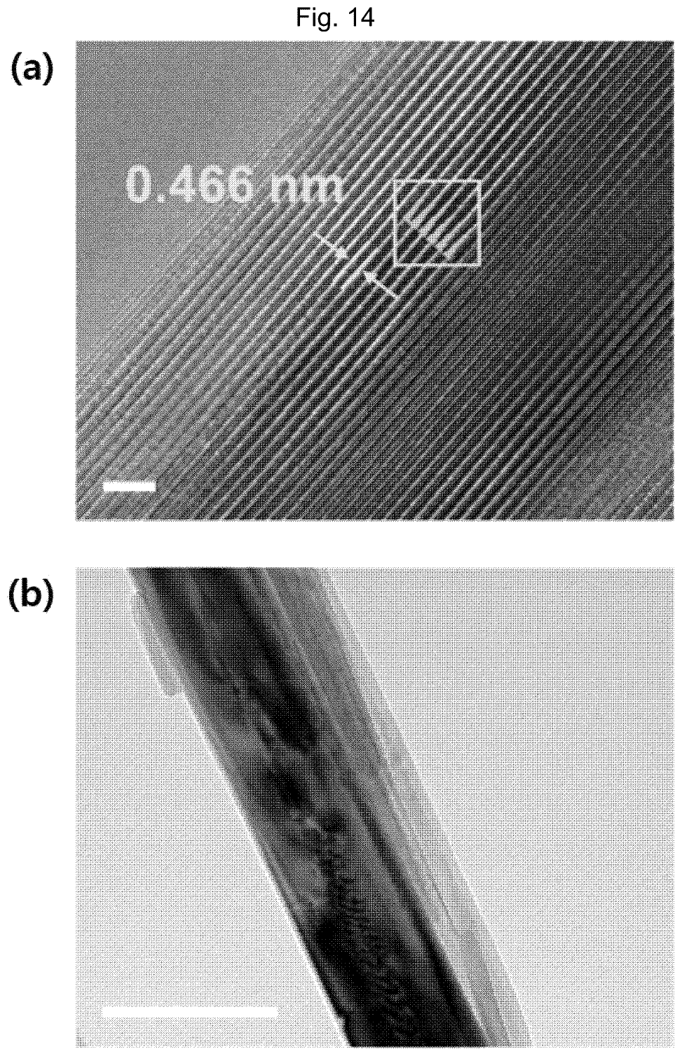

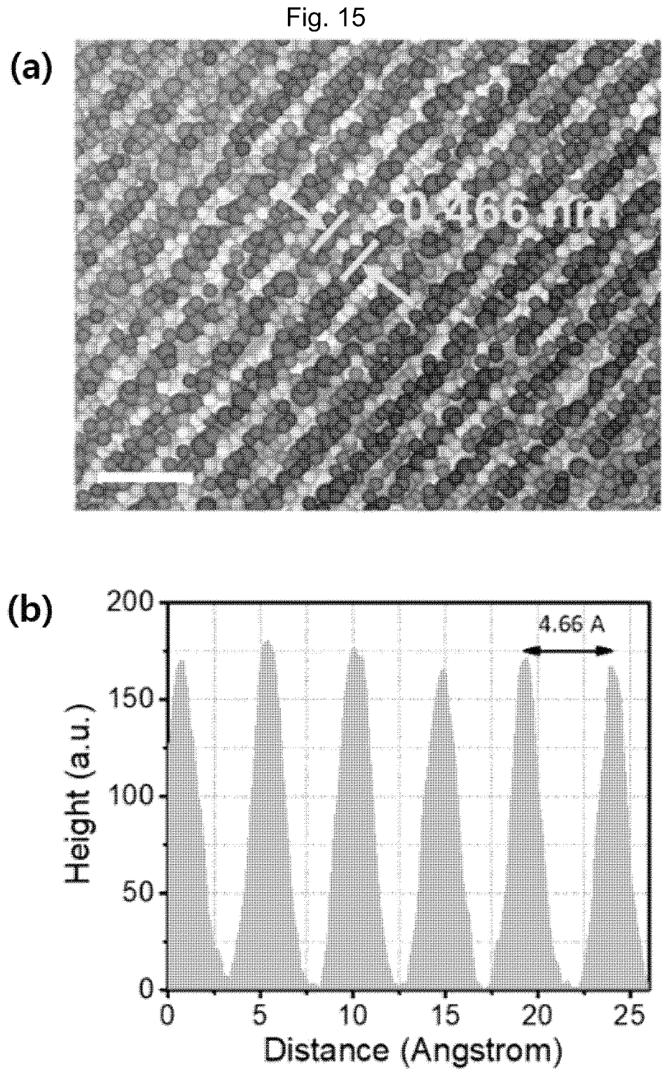

FIG. 13 is a view showing SEM pictures of an electrode structure according to Experimental Example 2-1 of the present application, FIG. 14 is a view showing TEM pictures of an electrode structure according to Experimental Example 2-1 of the present application, and FIG. 15 is a view showing a simulation and a lattice fringe image of an atomic structure of an electrode structure according to Experimental Example 2-1 of the present application.

Referring to FIGS. 13 to 15, SEM and TEM pictures were taken of the CuPS electrode structure (CuP_{0.5}S_{0.5}) according to Experimental Example 2-1, and a simulation and a lattice fringe image of an atomic structure of an electrode structure were displayed. (a) of FIG. 14 is a high-resolution (scale bar 2 nm) TEM picture of the electrode structure of Experimental Example 2-1, (b) of FIG. 14 is a low-resolution (scale bar 30 nm) TEM picture of the electrode structure of Experimental Example 2-1, (a) of FIG. 15 is a simulation showing an atomic arrangement of the crystal plane 101 of the electrode structure of Experimental Example 2-1, and (b) of FIG. 15 is a topographic plot profile of a lattice fringe image of the electrode structure of Experimental Example 2-1.

As can be understood from FIG. 13, it can be confirmed that a plurality of fibers form a network in the electrode structure of Experimental Example 2-1.

In addition, as can be understood from FIGS. 14 and 15, it can be confirmed that a lattice spacing of the electrode structure of Experimental Example 2-1 is 0.466 nm.

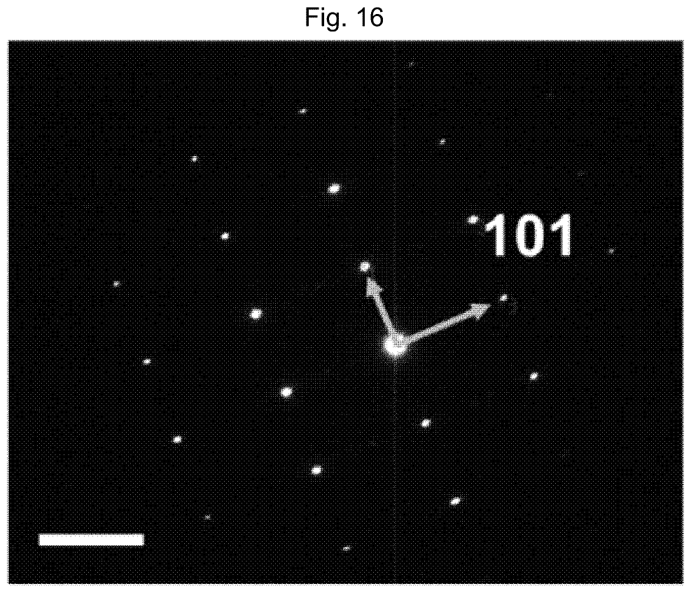

FIG. 16 is a view showing an SEAD pattern of an electrode structure according to Experimental Example 2-1 of the present application.

Referring to FIG. 16, an SEAD pattern (scale 2 nm-1) for a surface 101 of the CuPS electrode structure (CuP_{0.5}S_{0.5}) according to Experimental Example 2-1 described above was obtained.

As can be understood from FIG. 16, it can be seen that the electrode structure of Experimental Example 2-1 has an orthorhombic crystal structure having a crystal plane 101 and is formed of a compound of Cu, P and S.

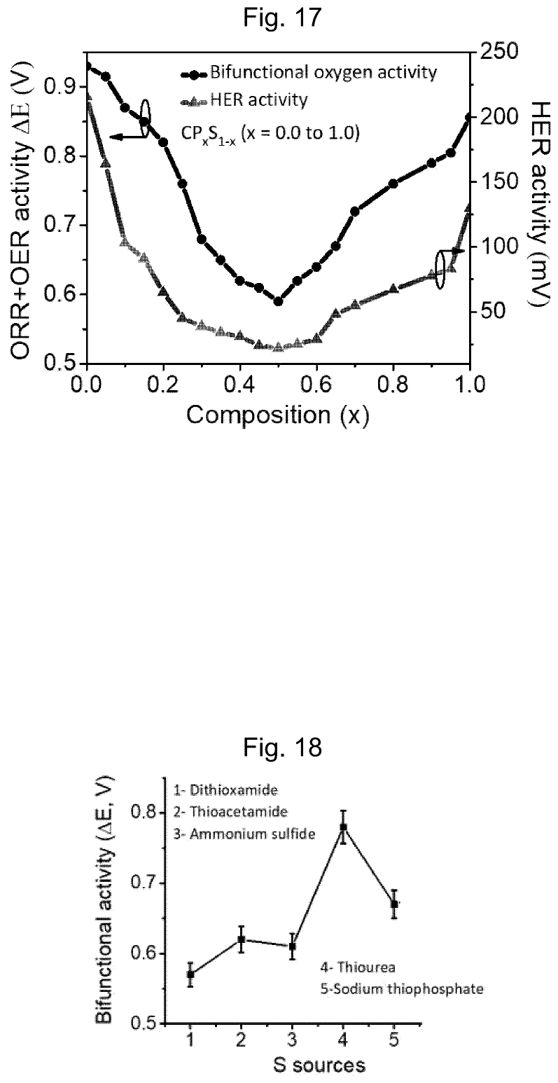

FIG. 17 is a graph showing an evaluation of ORR, OER, and HER properties according to a composition ratio of P and S in an electrode structure according to Experimental Example 2-1 of the present application.

Referring to FIG. 17, the ORR, OER, and HER properties according to a composition ratio of P and S were measured and shown with regard to the CuPS electrode structure according to Experimental Example 2-1.

As can be understood from FIG. 17, it can be confirmed for the CuPS electrode structure that ORR, OER and HER properties are excellent when a composition ratio of P is more than 0.3 and less than 0.7 and a composition ratio of S is less than 0.7 and more than 0.3. In other words, it can be confirmed for the CuPS electrode structure that controlling of the composition ratio of P to be more than 0.3 and less than 0.7 and the composition ratio of S to be less than 0.7 and more than 0.3 is an efficient method capable of improving ORR, OER and HER properties.

Manufacturing of Electrode Structure According to Experimental Example 2-2

An electrode structure according to Experimental Example 2-2 was manufactured by performing the method for manufacturing the electrode structure according to Experimental Example 2-1, but using ifosfamide as the second precursor having phosphorus.

Manufacturing of Electrode Structure According to Experimental Example 2-3

Dithiooxamide was prepared as a first precursor having sulfur, ifosfamide was prepared as a second precursor having phosphorus, copper chloride was prepared as a third precursor having copper, and a mixture of ethanol and ethylenediamine (1:3 v/v %) was prepared as a solvent.

The first to third precursors were added to the solvent and stirred to prepare a suspension.

2.5 M % ammonium hydroxide was added as a reducing agent, stirred for two hours without an additional heat-treatment process, after which an intermediate product was obtained, washed with deionized water and ethanol, and dried under vacuum at 50° C.

After that, the intermediate product was mixed and stirred in 20 ml of deionized water including Triton X-165 as a surfactant and a phosphorus acid source. After that, the resulting mixture was heat treated under pressure at 120° C. for 24 hours to prepare an electrode structure including a compound of copper, phosphorus and sulfur.

After that, the resulting product was washed with deionized water and ethanol to adjust to neutral pH, and freeze-dried in vacuum, so as to prepare a CuPS electrode structure according to Experimental Example 2-3.

Manufacturing of Electrode Structure According to Experimental Example 3

Dithiooxamide, thioacetamide, ammonium sulfide, thiourea, and sodium thiophosphate were prepared as a first precursor having sulfur; phosphorus acid, ifosfamide, triphenylphosphine, tetradecylphosphonic acid, and sodium thiophosphate were prepared as a second precursor having phosphorus; Mn chloride, Fe chloride, Co chloride, Ni chloride, Ca chloride, Zn chloride, and Mg chloride were prepared as a third precursor having a transition metal; distilled water, ethanol, oleylamine, dimethylformamide, ethylenediamide, and pyrrolidone were prepared as a solvent; and Triton X-165, Triton X-100, HCl, hexamethylenetetramine, polyoxyethylene, and dodecanol were prepared as a surfactant.

The first to third precursors were added to the ethanol and stirred to prepare a suspension.

2.5 M % ammonium hydroxide was added as a reducing agent, stirred for two hours without an additional heat-treatment process, after which an intermediate product was obtained, washed with deionized water and ethanol, and dried under vacuum at 50° C.

After that, the intermediate product was mixed and stirred in 20 ml of the solvent including the surfactant and a phosphorus acid source. After that, the resulting mixture was heat treated under pressure at 120° C. for 24 hours to manufacture an electrode structure including a compound of copper, phosphorus and sulfur.

After that, the resulting product was washed with deionized water and ethanol to adjust to neutral pH, and freeze-dried in vacuum, so as to manufacture a CuPS electrode structure.

The first to third precursors, the solvent, and the surfactant were used as follows.

Specifically, in Experimental Examples 3-1-1 to 3-1-5, phosphorus acid, Cu chloride, ethanol, and Triton X-165 were used as the second precursor, the third precursor, the solvent, and the surfactant.

TABLE 1

| Classification | First precursor |
|---|---|
| Experimental Example 3-1 | Dithiooxamide |
| Experimental Example 3-2 | Thioacetamide |
| Experimental Example 3-3 | ammonium sulfide |
| Experimental Example 3-4 | Thiourea |
| Experimental Example 3-5 | sodium thiophosphate |

In Experimental Examples 3-2-1 to 3-2-5, dithiooxamide, Cu chloride, ethanol, and Triton X-165 were used as the first precursor, the third precursor, the solvent, and the surfactant.

TABLE 2

| Classification | Second precursor |
|---|---|
| Experimental Example 3-2-1 | Phosphorus acid |
| Experimental Example 3-2-2 | Ifosfamide |
| Experimental Example 3-2-3 | triphenylphosphine |
| Experimental Example 3-2-4 | tetradecylphosphonic acid |
| Experimental Example 3-2-5 | sodium thiophosphate |

In Experimental Examples 3-3-1 to 3-3-6, dithiooxamide, phosphorus acid, Cu chloride, and ethanol were used as the first precursor, the second precursor, the third precursor, and the solvent.

TABLE 3

| Classification | Surfactant |
|---|---|
| Experimental Example 3-3-1 | Triton X-165 |
| Experimental Example 3-3-2 | Triton X-100 |
| Experimental Example 3-3-3 | HCl |
| Experimental Example 3-3-4 | Hexamethylenetetramine |
| Experimental Example 3-3-5 | polyoxyethylene |
| Experimental Example 3-3-6 | dodecanol |

In Experimental Examples 3-4-1 to 3-4-6, dithiooxamide, phosphorus acid, Cu chloride, and Triton X-165 were used as the first precursor, the second precursor, the third precursor, and the surfactant.

TABLE 4

| Classification | Solvent |
|---|---|
| Experimental Example 3-4-1 | Distilled water |
| Experimental Example 3-4-2 | Ethanol |
| Experimental Example 3-4-3 | Oleylamine |
| Experimental Example 3-4-4 | dimethylformamide |
| Experimental Example 3-4-5 | ethylenediamide |
| Experimental Example 3-4-6 | pyrrolidone |

In Experimental Examples 3-5-1 to 3-5-6, dithiooxamide, phosphorus acid, ethanol, and Triton X-165 were used as the first precursor, the second precursor, the solvent, and the surfactant.

TABLE 5

| Classification | Third precursor |
|---|---|
| Experimental Example 3-4-1 | Mn chloride |
| Experimental Example 3-4-2 | Fe chloride |
| Experimental Example 3-4-3 | Co chloride |
| Experimental Example 3-4-4 | Ni chloride |
| Experimental Example 3-4-5 | Ca chloride |
| Experimental Example 3-4-6 | Zn chloride |
| Experimental Example 3-4-7 | Mg chloride |
| Experimental Example 3-4-8 | Cu |

FIG. 18 is a graph showing a measurement of bifunctional activity of electrode structures according to Experimental Examples 3-1-1 and 3-1-5 of the present application.

Referring to FIG. 18, a bifunctional activity value of electrode structures according to Experimental Examples 3-1-1 and 3-1-5 of the present application was measured. A reversible bifunctional reaction of oxygen may be determined by a bifunctional activity value corresponding to a difference (AE) between the overpotentials of ORR and OER, and as the difference is smaller, the reversibility may be higher.

As shown in FIG. 18, a bifunctional activity value of electrode structures according to Experimental Examples 3-1-1 and 3-1-3 was measured to be relatively low, but a bifunctional activity value of electrode structures according to Experimental Examples 3-1-4 and 3-1-5 was measured to be relatively high. Specifically, it was confirmed that the activity for dithiooxamide, thioacetamide, and ammonium sulfide is excellent due to a covellite phase structure of the electrode structure, whereas thiourea and sodium thiophosphate are relatively less active due to a formation of a chalcocite structure. In conclusion, it can be confirmed that controlling the first precursor including sulfur to include any one of dithiooxamide, thioacetamide, or ammonium sulfide is an efficient method for improving the electrochemical properties of the electrode structure.

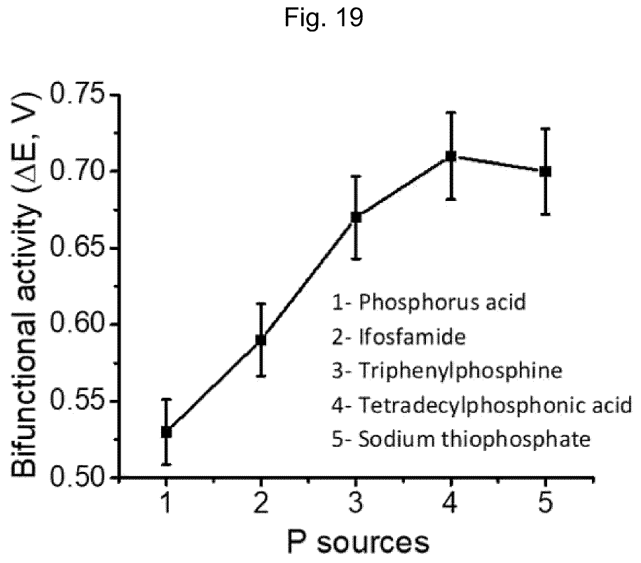

FIG. 19 is a graph showing a measurement of bifunctional activity of electrode structures according to Experimental Examples 3-2-1 and 3-2-5 of the present application.

Referring to FIG. 19, a bifunctional activity value of electrode structures according to Experimental Examples 3-2-1 and 3-2-5 of the present application was measured.

As shown in FIG. 19, a bifunctional activity value of electrode structures according to Experimental Examples 3-2-1 and 3-2-2 was measured to be relatively low, but a bifunctional activity value of electrode structures according to Experimental Examples 3-1-3 and 3-1-5 was measured to be relatively high. In conclusion, it can be confirmed that controlling the second precursor including phosphorus to include any one of phosphorus acid or ifosfamide is an efficient method for improving the electrochemical properties of the electrode structure.

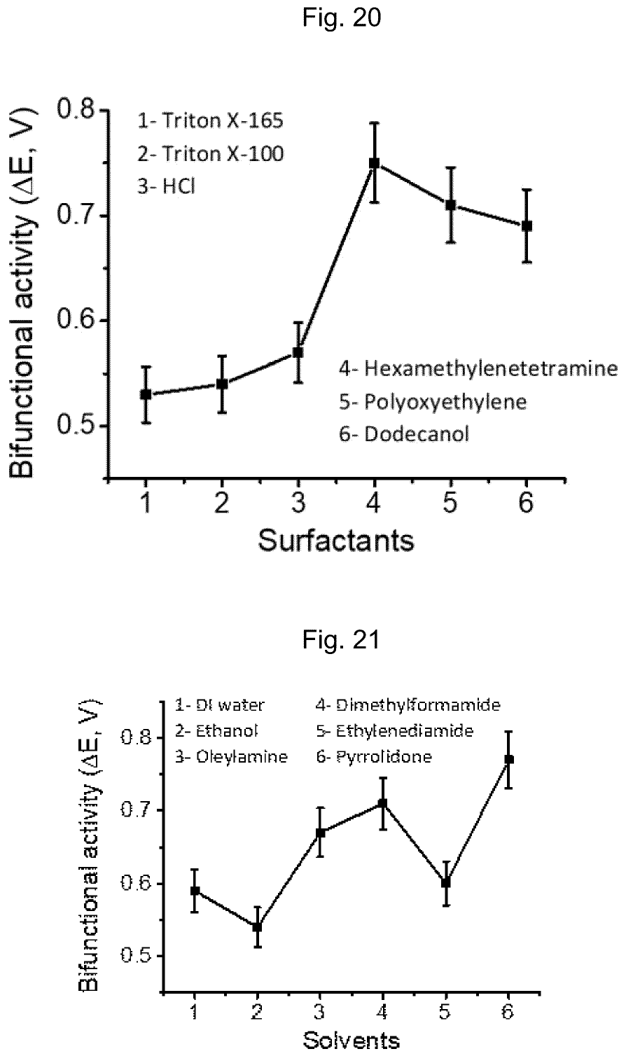

FIG. 20 is a graph showing a measurement of bifunctional activity of electrode structures according to Experimental Examples 3-3-1 and 3-3-6 of the present application.

Referring to FIG. 20, a bifunctional activity value of electrode structures according to Experimental Examples 3-3-1 and 3-3-6 of the present application was measured.

As shown in FIG. 20, a bifunctional activity value of electrode structures according to Experimental Examples 3-3-1 and 3-3-3 was measured to be relatively low, but a bifunctional activity value of electrode structures according to Experimental Examples 3-3-4 and 3-3-6 was measured to be relatively high. In conclusion, it can be confirmed that controlling the surfactant to include any one of Triton X-165, Triton X-100, or HCl is an efficient method for improving the electrochemical properties of the electrode structure.

FIG. 21 is a graph showing a measurement of bifunctional activity of electrode structures according to Experimental Examples 3-4-1 and 3-4-6 of the present application.

Referring to FIG. 21, a bifunctional activity value of electrode structures according to Experimental Examples 3-4-1 and 3-4-6 of the present application was measured.

As shown in FIG. 21, a bifunctional activity value of electrode structures according to Experimental Examples 3-4-1 to 3-4-2 and 3-4-5 was measured to be relatively low, but a bifunctional activity value of electrode structures according to Experimental Examples 3-4-3 to 3-4-4 and 3-4-6 was measured to be relatively high. In conclusion, it can be confirmed that controlling the solvent to include any one of distilled water, alcohol including ethanol, or ethylenediamide is an efficient method for improving the electrochemical properties of the electrode structure.

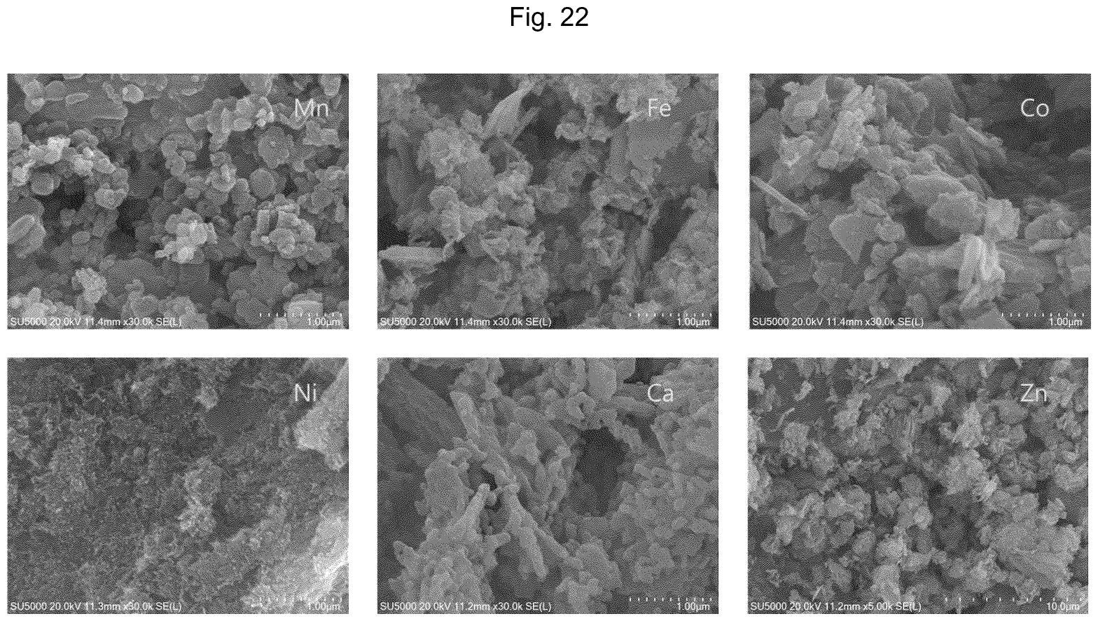

FIG. 22 is a view showing an SEM picture of an electrode structure according to Experimental Examples 3-5-1 to 3-5-6 of the present application.

Referring to FIG. 22, an SEM picture was taken of electrode structures according to Experimental Examples 3-5-1 to 3-5-6.

As can be understood from FIG. 22, it can be confirmed that the surface morphology and profile of an electrode structure are controlled according to a type of metal.

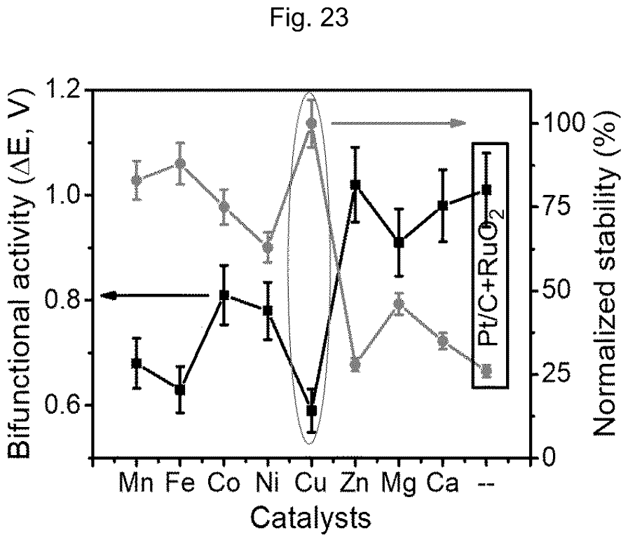

FIG. 23 is a graph showing a measurement of bifunctional activity of electrode structures according to Experimental Examples 3-5-1 and 3-5-8 of the present application.

Referring to FIG. 23, a bifunctional activity value of electrode structures according to Experimental Examples 3-5-1 and 3-5-8 of the present application was measured.

As shown in FIG. 23, a bifunctional activity value of electrode structures according to Experimental Examples 3-5-1 to 3-5-2 and 3-5-8 was measured to be relatively low, but a bifunctional activity value of electrode structures according to Experimental Examples 3-5-3 to 3-5-7 was measured to be relatively high, thereby showing low stability. In conclusion, it can be confirmed that controlling the transition metal to include one of Mn, Fe and Cu is an efficient method for improving the electrochemical properties of the electrode structure.

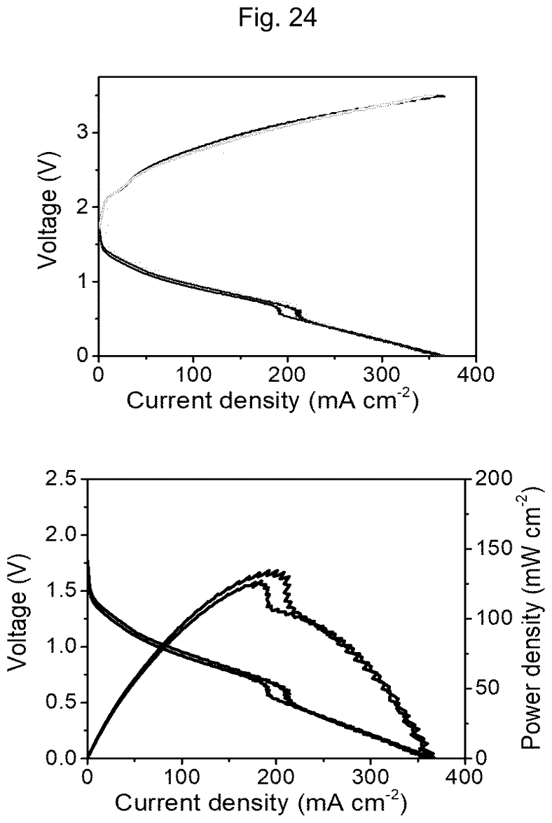

FIG. 24 is a graph for explaining a result of charge/discharge properties of an aluminum-air battery according to an experimental example of the present application.

Referring to FIG. 24, according to Experimental Example 3, an electrode structure manufactured using dithiooxamide, phosphorus acid, Cu chloride, ethanol, and Triton X-165 as a first precursor, a second precursor, a third precursor, a solvent, and a surfactant was used as a positive electrode, a solid electrolyte according to Experimental Example 1-4 was used, and an aluminum foil was used as a negative electrode, so as to manufacture a pouch-type aluminum-air secondary battery.

As can be understood from FIG. 24, it can be confirmed that charging and discharging are reversibly performed, and a power density at a level of about 130 mW/cm² is obtained. In conclusion, it can be confirmed that a high-capacity and high-efficiency aluminum-air secondary battery capable of being charged and discharged substantially a plurality of times may be implemented using the electrode structure and the solid electrolyte according to an embodiment of the present application.

Although the present invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

An electrode structure according to an exemplary embodiment of the present application may be utilized in various industrial fields such as a metal-air secondary battery, a lithium ion secondary battery, etc.

What is claimed is:

1. An aluminum-air secondary battery capable of being charged and discharged a plurality of times, wherein the aluminum-air secondary battery comprises:
a positive electrode including an electrode structure formed of a compound containing a transition metal, a chalcogen element, and phosphorus;
a negative electrode disposed on the positive electrode and containing aluminum; and
a solid electrolyte disposed between the positive electrode and the negative electrode and containing a base composite fiber having bacterial cellulose and chitosan bound to the bacterial cellulose.

2. The aluminum-air secondary battery of claim 1, wherein the electrode structure comprises a membrane in which a plurality of fibrillated fibers form a network, and is flexible.

3. The aluminum-air secondary battery of claim 1, wherein the transition metal of the electrode structure comprises at least one of Cu, Mn, Fe, Co, Ni, Zn, Mg, or Ca, and
the chalcogen element of the electrode structure comprises sulfur.

4. The aluminum-air secondary battery of claim 1, wherein the solid electrolyte comprises a first composite fiber that is formed as a surface of the base composite fiber is oxidized, and a second composite fiber that is formed as a first functional group having nitrogen is bound to a surface of the base composite fiber.

5. The aluminum-air secondary battery of claim 1, wherein weight ratios of the first composite fiber and the second composite fiber in the solid electrolyte are same as each other.

6. The aluminum-air secondary battery of claim 1, wherein a capacity is 1,800 mAh/g or more and an energy density is 3.00 Wh/Kg or more.

7. The aluminum-air secondary battery of claim 1, wherein the transition metal of the electrode structure comprises copper, and the electrode structure is represented by <Formula 1> below. <Formula 1> CuPₓS_{y} (wherein x+y=1, 0.3≤x≤0.7, 0.3≤y≤0.7)

8. A method for manufacturing an aluminum-air secondary battery capable of being charged and discharged a plurality of times,
the method comprising:
providing a positive electrode including an electrode structure formed of a compound containing a transition metal, a chalcogen element, and phosphorus;
disposing a solid electrolyte including bacterial cellulose, and a base composite fiber having chitosan bound to the bacterial cellulose, on the positive electrode; and
disposing a negative electrode including aluminum on the solid electrolyte.

9. The method of claim 8, wherein the providing of the positive electrode including the electrode structure comprises:
providing a first precursor having a chalcogen element, a second precursor having phosphorus, and a third precursor having a transition metal;
mixing the first precursor, the second precursor, and the third precursor in a first solvent to prepare a suspension;
adding a reducing agent to the suspension and causing a reaction therebetween to produce an intermediate product; and
manufacturing the electrode structure including the chalcogen element, the phosphorus, and the transition metal by adding the intermediate product and the surfactant to a second solvent and performing a heat treatment under pressure.

10. The method of claim 8, wherein the disposing of the solid electrolyte comprises:
providing a chitosan derivative;
producing chitosan bound to cellulose from the chitosan derivative; and
preparing a solid electrolyte by using the cellulose to which the chitosan is bound.
